(19) United States
(12) Patent Application Publication
(10) Pub. No.: US 2009/0110791 A1
(43) Pub. Date: Apr. 30, 2009

(54) Produce processor

(76) Inventors: David R. Burley, Anderson, SC (US); Edward E. Blanton, Belton, SC (US)

Correspondence Address: MCNAIR LAW FIRM, P.A., P.O. BOX 447, GREENVILLE, SC, 29602-0447, US

(21) Appl. No.: 12/290,442

(22) Filed: Oct. 30, 2008

Related U.S. Application Data
(60) Provisional application No. 61/001,279, filed on Oct. 31, 2007.

(51) Int. Cl. A23L 3/10

(52) U.S. Cl. 426/407

(57) ABSTRACT

A process for treating a farm product by heating and cooling, said treatment may include pasteurization of a product within the container in which they are to be sold by placing sealed containers containing the products within a process tank causing the products to move within the containers to enhance heat transfer into the product, holding the product at a desired temperature and then cooling the container while in the tank and distributing the containers to be sold.

### CROSS REFERENCE

This application claims priority from U.S. Provisional Application Ser. No. 61/001,279, filed Oct. 31, 2007.

### FIELD OF THE INVENTION

This invention relates to a process for on-the-farm treatment of produce, milk, and milk products by heating and/or cooling. More specifically this invention relates to a process for pasteurizing milk and similar products in the package or container in which it will be sold.

### BACKGROUND

Small farmers often are limited in their ability to market their products as they do not have pasteurized products to sell into normal commercial channels. For example, as a result of a limited market due to a lack of pasteurization, the goat farmer is limited in the size of his herd and the potential for a variety of products that can be sold by supermarkets and other commercial channels. Likewise, the apple farmer cannot often get his juice to the market, since it is unstable due to indigenous fermentation and may contain e.Coli bacterial contamination. Dairy farmers from large to small all have the potential to spread disease throughout the herd by using milk from infected mothers to feed newborn kids, calves and lambs. Eggs are often contaminated through the shells or minor cracks that can introduce e.Coli and other contaminates. Thus, a need exists for farmers to have an on-the-farm means for processing and packaging their produce in market ready packages.

Some prior art developments are described in U.S. Pat. No. 1,359,214 to G. E. Page entitled “Machine for Pasteurizing Milk and Other Liquids”; in U.S. Pat. No. 2,769,564 to O. G. Hoggren entitled “Portable Milk Pasteurizer”; in U.S. Pat. No. 5,503,064 to Fredrick S. Scheel, et al. entitled “Apparatus and Method for Controlling a Pasteurizing System”; and in “Installation Manuel and Operating Procedures” by Milk-Pro International of Bryanston, South Africa, URL: www.milk-pro.com. Pasteurization of treated fresh fruit is described in “Packaged Pasteurized Fresh Fruits and Method for Production, US 2006/0034980 A1 to Richard R. Perdue, published Feb. 16, 2006.

In use today for milk, for example, is the high temperature, short time process, typically 161° F. to 175° F. for 15 to 25 seconds (HTST), and the ultra high temperature process, 280° F. for two seconds (UHT). In all these processes rapid chilling to below 40° F. after heating is very important. Vat pasteurization, which is a process similar to the process employed in the present invention, requires about 145° F. to 155° F. for 30 minutes. This is the long time, low temperature process (LTLT). These times and temperatures vary according to fat content and any added sweeteners. The object in the pasteurization processes is to obtain a logarithmic reduction of pathogenic organisms to a level that is unlikely to cause disease if the produce or milk is refrigerated and consumed before the expiration date. All three processes mentioned above produce milk that must be refrigerated and has limited storage or shelf time. Similar pasteurization process may be used for goat milk, fruit juices, and even some fruit products.

### SUMMARY OF THE INVENTION

The invention in a primary aspect is a process for treating a farm product packaged in the container in which it is to be sold by heating and cooling the product in the container to preserve the product for safe consumption. If desired, the product may be kept in the same container not only reducing labor and material costs, but any possibility of introducing contamination by filling subsequent containers for storage and marketing is eliminated but flavor is preserved. Milk, yogurt, and semi-solid cheeses are particularly benefited by the process of this invention. Milk may be pasteurized and sold in the same container. Yogurt can be fermented, pasteurized, and sold in the same container. The pasteurization will virtually stop fermentation and preserve the yogurt longer. Heat and cooling is achieved by circulating heated or chilled liquid around and in contact with the container walls. The circulation may be from circulation of the liquid or by spraying. Inside the container, as the walls are heated or cooled convection currents are set up and cause movement in both rigid wall and flexible wall containers. To increase the speed of heat transfer, vibration of the container, or flexing of the container walls by pulsing outside fluid flaw or spraying can be done. Also reciprocal motion of a support platform for the container may be employed.

In a particular aspect, the invention is a process for pasteurization that can employ the low temperature, long term process in the retail container to assure that every particle of processed milk is pasteurized according to FDA requirements; but, the present invention has the flexibility to use higher temperature for more rapid pasteurization when desired. The process can be used to pasteurize milk, semi-solid cheese, juice, fruit and eggs among many items and can be used for any or all of these products singularly or simultaneously, if desired, since the products are packaged and pasteurized in the container in which the products are sold. This means contamination of products is not possible during or after pasteurization, so an apple farmer who also has a dairy can pasteurize milk and apple juice. Different sizes of products can be produced simultaneously from gallons to pints, for example. Benefits from this are that complicated machines needing constant expert attention are eliminated and the shelf life of the produce is extended since the container is simultaneously pasteurized. Even in states where milk is sold unpasteurized by the farmer or in relatively rare instance from health food stores, the major market for small farmers is automatically excluded because most supermarkets will require a pasteurized, homogenized product in an approved container.

In a particularly useful aspect of the invention, a product to be pasteurized such as milk or apple juice is poured into a container with flexible wall and sealed leaving a space at the top. The container is preferably a conventional plastic milk jug of half gallon or gallon capacity which has flexible side walls or it may be a carton-like structure of plastic, metal, or metal foil material; or, the container may be a plastic pouch or sachet. These containers are semi-rigid or rigid depending on the container configuration, the material of construction, wall thickness and structured feature. The filled container is secured within a process tank to restrain its movement and the tank filled with heated water. The water is circulated and a pulsed stream is directed against the flexible walls thus causing the milk therein to be circulated for more rapid heat transfer. Alternately, while the process tank is being filled spray can be directed against the container loaded in the tank. When cooling, the pulsation of chilled water against the flexible walls will circulate the milk and causes more rapid cooling. Thus, the milk is “stirred” without moving the container from its position. The filled containers remain in their positions by being restrained in a rack which will allow minimal movement and does not keep the container in a completely rigid grasp. For example, such a rack could resemble a typical partitioned bottle rack used for shipping of cases of wine, beer, or other bottled items but would be made of stainless steel or heat setting plastic. The container remains sealed at all times. In the case of rigid glass bottles, vibration of the bottles can be done. This has the effect of moving the milk within the bottle.

In another aspect of the invention conventional containers may be used for pasteurization such as standard plastic or glass milk bottles. The choice and size of the container can be made to meet market demand and acceptance. The operating parameters of the process of the invention, especially time, will be affected by the choice of container. Thus, larger containers and those with low thermal conductivity such as glass slow the process by delaying the approach to the desired temperature and the walls cannot be flexed as described above. For rigid containers, the internal “stirring” or movement for more rapid and uniform heat transfer can be achieved by vibrating the containers or by subjecting them to reciprocal motion. In the vibration method a platform is positioned at the bottom on the tank with bottles placed thereon which are separated by spacers. The platform is operably connected to vibrating means to vibrate the bottles when water is introduced. In the reciprocating motion method the platform is moved back and forth to case internal stirring of the milk. Accordingly, smaller containers of glass are desirable to speed up the heat transfer process.

The maintenance of an effective temperature is the step of controlling the temperature which may be done using a controller, which is an important feature of this invention although the steps may be performed manually the controller allows the steps to be performed with greater ease and precision. Lower pasteurization temperatures will produce superior products as far as taste is concerned, but higher temperatures are available should the operator choose this option to speed the process.

Pasteurization as opposed to sterilization is for the reduction of pathogens to a safe level, not necessarily the elimination of them. The process in another aspect can be considered to be a “heat treatment” process at a lower temperature for a longer period to assure that small animals get milk which is free of harmful bacteria but still contains the necessary antibodies for the young animals' health. This reduces spreading of bacteria from an infected mother to the entire herd. The milk can be heat treated in bottles which contain nipples and fed immediately after controlled cooling.

In yet another aspect, with this invention it is possible to produce raw milk cheese, package it and pasteurize it in the package. Flexible, polymeric bags and pouches are available with oxygen and moisture barrier properties and sufficient seal strength at the pasteurization temperature of this invention. This maintains the taste from raw milk cheese which some consider superior and simultaneously eliminates disease from Listeria which can grow at storage temperatures in contaminated packages. The problem of Listeria is serious, especially with foreign cheeses. Listeria can cause death in infants and adults with a compromised immune system. Even foreign cheeses could be pasteurized before sale. Since cheese is solid or semi-solid it does not readily move within a package and for efficiency the cheese should be then sliced for better heat transfer.

A significant advantage to the present invention is that it does not require expensive and difficult to maintain pasteurizing and bottling equipment. The FDA “no dipping” rule prevents a small farmer from pasteurizing milk and then filling the bottles manually. Our invention allows the farmer to fill the containers before pasteurization and immediately have a product for sale after the pasteurization process.

In one embodiment of our invention, containers of product need to be held in only one process tank while hot and cold water is pumped in and circulated to heat and, after sufficient heating, cold water sprayed in as the hot water is removed to cool the products through the temperature cycles required to pasteurize or heat treat the products. This is controlled by a programmable processor to open and close valves and turn on and off pumps to control the flows of water. One feature of this embodiment is that water levels are changed at predetermined times in the process to prevent contamination. For example, during the heating stage the water level is 1 or more inches above the top of the containers, as is the guideline in canning. During cooling it is preferred to have the water level 1 inch or so below the top of the container to prevent the entry of water as the container cools should a leak develop in the closure seal of the package. This may not be necessary if the containers are hermetically sealed. One means for dealing with this is to position level switches in the process tank and/or to place racks in the process tank for the containers.

During the cooling and heating steps, the storage tank is utilized to hold hot and cold water. This tank's purpose is to provide the ability to heat and cool quicker than the actual heating and cooling capacity of the units for this purpose. Thus, a container is heated to the desired temperature by a water heater which is separate from the storage tank. During the heating of the water in the process tank, the water of the storage tank is used to heat the process tank and the water in the process tank is circulated to the storage tank. The same procedure is followed for the chilled water. The transition from heating to cooling is an energy saving step, which also takes the temperature of the process tank into the most efficient range for the cooling which is to use tap water, preferably well water, especially in warm climates, to pre-cool the contents of the process tank to 90° F. This water can be pumped to a storage tank for use as warm water or, if desired, pumped in as make-up water to the hot water storage tank. The chilled water is pumped in after the warm water is pumped out and circulated to reach the desired temperature. For long term storage, the preferred temperature is 40° F. or lower. In other uses such as cooling raw milk this method of pumping chilled water into the loaded process tank will cool milk quickly and allow it to be stored before processing and then sold where such sale meets the health laws and regulations. This method of chilling is superior to one which uses only chilled air as in normal coolers. It is also possible to divert this chilled water stream to an overnight storage tank, often called a bulk tank. This bulk tank preferably has a two layered shell or tubing through which the cold water is circulated to chill the contents and is a normal holding tank at most dairies.

The lid to the process tank is locked at the start of the process and only unlocks when the chosen process is finished to assure the quality of the batch. If one were to have two tanks of hot and cold water in which the product was moved from one to the other, such assurance would not be there. This is one of the reasons a single process tank is superior, as well as the reduction in labor. The single process tank with flow and temperature controlled by a processor assures quality and allows the farmer and his help to be freed for other duties. The milk or product at the end of this process is stored at chiller temperature of 40° F. or below until the product is unloaded into the cooler for storage to transport to market.

### IN THE DRAWING

In the drawings which are appended hereto by way of illustration and not limitation:

FIG. 1 is a schematic representation showing a layout of equipment for performing a preferred process according to the invention.

### DETAILED DESCRIPTION

The operation of one embodiment of the process of the invention will now be generally described. The use of equipment as described for use in the process can be obtained by anyone skilled in the art who would be directed by this disclosure. The process begins by: filling the hot and cold water storage tanks. Once filled both hot and cold water pumps will turn on and begin filling the hot water heater and the chiller. This will temporarily lower the water level in both storage tanks until the heater and chiller are full, then the storage tanks will re-fill. At this point the heater and the chiller will begin to operate and drive the water temperature to the pre-set values, typically 175° F. for hot water and 40° F. for cold water. It takes approximately 2 hours to make the system ready to begin operations; depending on ambient temperatures and the temperature of the incoming water and selected sizes of the processing tanks. Once the water in the hot water storage tank is brought up to the pre-set minimum temperature of 145° F. the system is ready.

Next, the product being processed is loaded. The products that can be processed are:
1) Milk
   A. Standard milk pasteurization
   B. Chill mode only
2) Juice
   A. Apple
   B. Grape
   C. Pineapple
3) Colostrum
   A. Cow
   B. Goat
   C. Sheet
   D. Horse
   E. Zoo
4) Cheese Milk
5) Cheese Blocks
6) Yogurt

Each product requires a different processing condition. For example, in the milk pasteurization process, the preferred level is 151° F. pasteurization temperature and 30 minutes pasteurization time, 3 minutes well or tap water soak time, followed by a chill temperature of 40° F. that is carried out to achieve the proper results.

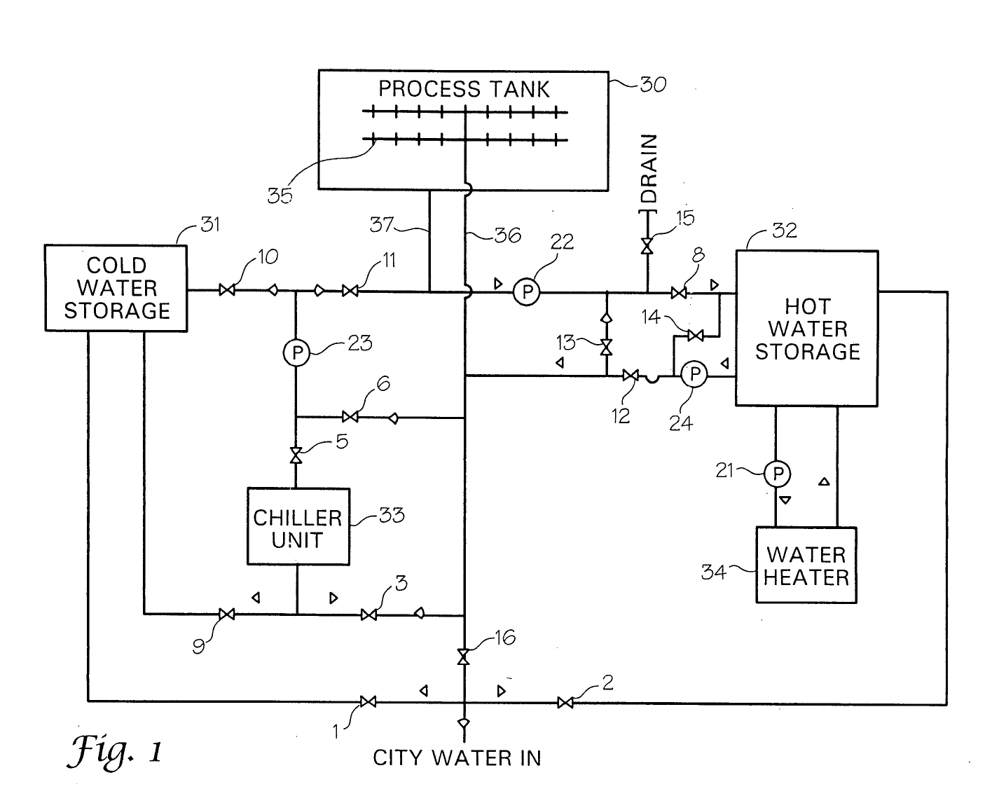

Referring now to FIG. 1, a preferred embodiment and best mode of the invention will be described. Water is heated by 21 circulating water from the storage tank 32 through the water heater 34 to a set point of 70-175° F. Once the process tank 30 has filled to a level 1.5 inches above the top of the containers, by valve 12 and pump 24, valve 8 and pump 22 will remove an equal amount of water in the process tank 30 to maintain a level of 1.5-2 inches above the container. This continues until the temperature set point is reached then valve 13 opens and pump 22 circulates the water in the process tank 30, also valve 14 and pump 24 are on so as to be ready to provide more hot water to the process tank when the temperature fall below the set point by closing valves 13 and 14 and opening valve 8 and 12. This enables the system to hold the temperature to within 0.5° F. The temperature is monitored via a RTD (Resistive Temperature Device) mounted in the bottom of the process tank where the temperature is the coldest. The RTD signal is received by the PLC (a programmed, process controller) where it not only controls the temperature, but also generates a signal to plot the temperature on a circular chart recorder for a permanent record. The heat up portion of the cycle typically takes 15-30 minutes to reach set point. The temperature must maintain set point for 6 minutes without falling below set point, otherwise the 6 minute timer will start over. Once achieved, the 30 minute timer begins to time, meanwhile the pump and control valves maintain temperature at 151 degs F.±4° F. If for any reason, the temperature falls below set point at any time during the 6 or 30 minute timers, both timers will start over. This can happen twice before an error will occur and the cycle stopped.

After the 30 minute pasteurization portion of the cycle has finished pump 22 and valve 8 turns on to drain the water from the process tank 30 back into the hot water storage tank. If the hot water storage tank 32 becomes full before the process tank 30 empties, valve 15 will open and valve 8 closes to discharge any extra water. Then, valve 16 opens to fill the process tank with an intermediate cooling step of city or well water to minimize potential heat and dissipate much of the heat before the final chill portion of the cycle. Once filled the city water soaks/circulates for 3 minutes then drains when valve 15 and pump 22 turn on. Any water discharged through the drain can be recycled for other uses or used for makeup water in either storage tank. Make up water and initial filling of the cold water storage 31 and hot water storage 32 is done by opening valves 1 and 2.

Next, the process tank 30 is filled with chilled water as valves 3, 5, 10 and pump 23 turn on. Once filled to one inch below the caps of the containers, valves 3, 5, 11, and pump 23 will circulate the water in the process tank through the chiller 33 until a set point of 40° F. has been reached. The set point must be maintained for 6 minutes. If the temperature rises above the set point for any reason the timer will start over. Mean while valves 3 and 5 will close and valve 6 will open to keep the water in the process tank circulating. After the 6 minute timer has finished a cycle stop light and an outside alarm will turn on to alert the operator that the cycle has finished. Until the cycle stop button is pressed valves 3, 5, 11 and pump 23 or valves 6, 11 and pump 23 will keep the water at set point indefinitely, so as not to allow the product in the process tank to heat up to ambient temperatures. This enables the operator to unload the product from the process tank whenever he wants.

As mentioned above, the sequence of opening and closing the valves and starting and stopping pumps as described above can be accomplished by a programmed process controller that can be readily programmed by one skilled in the art to perform these functions.

The heating process can be accelerated by increasing the heat input to the water heater. The unit sizes will vary according to the projected output that a farmer desires; that is, according to the output of his dairy.

In addition to using the water spray within a tank to flex and vibrate the flexible walls of the restrained container, the support platform on which the containers rest within the process tank can be flexibly mounted on springs and vibrated or reciprocally moved backward and forward so that the reversal of motion causes a stirring within the container to bring uniform heating and pasteurization to the milk within the container. Furthermore, the heating and cooling processes may be performed by heating water in-line and cooling it in-line. In-line heating may be done in conjunction with the hot water storage tank when higher BTU input is desired.

### EXAMPLE

Thirty-six (36), one gallon plastic jugs filled with water were placed in a process tank with the beginning temperature being 40° F. The temperature of the hot water introduced into the tank was 158.4° F. Probes were positioned inside a test jug at the positions indicated in Table I below. In the positions indicated the probes were 0.25 to 0.50 inches from the container wall. Within a 200 minute span the temperature was raised and returned to 40° F. during that time span and remained above 150° F. for about 35 minutes.

The detailed results are shown in Table I below. As mentioned above, this process can be automated so that the farmer can go about other chores and the time lapse is acceptable whereas in a high-speed milk processing plat it would not.

TABLE I
Hot Water Start temperature = 158.4 F. Milk Start temperature = 40 F.
Ambient Room Temperature = 76 F.

| | Bottom | Bottom | Middle | Middle | Top | Top | Air Abov | | | |
|---|---|---|---|---|---|---|---|---|---|---|
| | Left | Center | Left | Center | Left | Center | Jug | A | B | C |
| 5 | 71 | 62 | 88 | 85 | 138 | 139 | 139 | 138 | 138 | 136 |
| 10 | 96 | 97 | 118 | 115 | 136 | 137 | 135 | 135 | 134 | 132 |
| 15 | 114 | 111 | 126 | 124 | 135 | 135 | 130 | 135 | 135 | 132 |
| 20 | 123 | 122 | 132 | 131 | 135 | 134 | 133 | 135 | 135 | 134 |
| 25 | 128 | 128 | 133 | 133 | 135 | 135 | 135 | 137 | 136 | 136 |
| 30 | 132 | 132 | 135 | 135 | 137 | 137 | 137 | 140 | 139 | 139 |
| 35 | 135 | 136 | 137 | 137 | 139 | 139 | 139 | 141 | 141 | 141 |
| 40 | 138 | 137 | 139 | 139 | 141 | 141 | 143 | 143 | 143 | 143 |
| 45 | 140 | 140 | 141 | 141 | 143 | 143 | 145 | 145 | 145 | 145 |
| 50 | 142 | 142 | 143 | 143 | 145 | 145 | 147 | 147 | 147 | 147 |
| 55 | 144 | 144 | 145 | 145 | 147 | 147 | 149 | 149 | 149 | 149 |
| 60 | 146 | 146 | 147 | 147 | 149 | 149 | 152 | 151 | 151 | 151 |
| 65 | 149 | 148 | 149 | 149 | 151 | 151 | 151 | 151 | 151 | 151 |
| 70 | 150 | 150 | 151 | 151 | 151 | 151 | 151 | 151 | 151 | 151 |
| 75 | 151 | 151 | 151 | 151 | 151 | 151 | 152 | 152 | 152 | 152 |
| 80 | 151 | 151 | 151 | 151 | 151 | 151 | 152 | 152 | 152 | 152 |
| 85 | 152 | 151 | 152 | 152 | 152 | 152 | 152 | 152 | 152 | 152 |
| 90 | 152 | 152 | 152 | 152 | 152 | 152 | 152 | 152 | 152 | 152 |
| 95 | 152 | 152 | 152 | 152 | 152 | 152 | 152 | 152 | 152 | 152 |
| 100 | 152 | 152 | 152 | 152 | 152 | 152 | 152 | 152 | 152 | 152 |
| 105 | 151 | 151 | 152 | 152 | 152 | 152 | 151 | No Water | | |
| 110 | 107 | 111 | 134 | 136 | 137 | 137 | 126 | 109 | 107 | 109 |
| 115 | 115 | 115 | 127 | 127 | 130 | 131 | No Water | | | |
| 120 | 87 | 88 | 108 | 107 | 108 | 108 | 81 | 71 | 73 | 68 |
| 125 | 74 | 75 | 94 | 93 | 95 | 95 | 77 | 73 | 74 | 72 |
| 130 | 73 | 74 | 86 | 86 | 87 | 86 | 76 | 71 | 71 | 71 |
| 135 | 71 | 72 | 80 | 80 | 81 | 80 | 71 | 68 | 68 | 68 |
| 140 | 69 | 70 | 76 | 76 | 77 | 77 | 69 | 66 | 66 | 65 |
| 145 | 66 | 67 | 72 | 72 | 73 | 73 | 66 | 63 | 63 | 63 |
| 150 | 63 | 64 | 69 | 69 | 70 | 70 | 65 | 60 | 61 | 60 |
| 155 | 61 | 61 | 67 | 67 | 67 | 67 | 61 | 58 | 58 | 57 |
| 160 | 58 | 58 | 63 | 63 | 64 | 64 | 57 | 56 | 56 | 55 |
| 165 | 56 | 56 | 61 | 61 | 62 | 62 | 55 | 53 | 53 | 52 |
| 170 | 54 | 55 | 59 | 59 | 59 | 59 | 53 | 51 | 51 | 50 |
| 175 | 52 | 52 | 57 | 57 | 57 | 57 | 51 | 49 | 49 | 49 |
| 180 | 49 | 49 | 54 | 54 | 55 | 55 | 49 | 48 | 48 | 47 |
| 185 | 48 | 48 | 53 | 52 | 53 | 53 | 47 | 45 | 45 | 45 |
| 190 | 46 | 46 | 50 | 51 | 51 | 51 | 45 | 43 | 43 | 43 |
| 195 | 44 | 44 | 48 | 48 | 49 | 49 | 44 | 43 | 43 | 42 |
| 200 | 42 | 42 | 47 | 47 | 47 | 47 | 41 | 40 | 40 | 39 |
| 205 | 40 | 40 | 44 | 44 | 45 | 45 | 40 | 40 | 40 | 40 |

Modification of our invention may become evident to those who have read the foregoing disclosure but our invention is limited only by the following claims.

We claim:

1. A process for preserving farm products by heating and cooling treatment of a product within a container while the container is positioned in a single process tank and remains there through the treating process to reduce contamination and enhance the flavor of the product comprising the steps of:
a) filling and sealing a container with a product to be treated and stored in said same container;
b) positioning the filled container in a process tank so that its movement from its position is restrained but minimal movement at the position can take place;
c) filling the process tank with water heated to a pre-determined temperature level to cover said container;
d) causing the contents of the container to move while circulating heated water around the container for a pre-selected period of time;
e) removing the heated water and filling the tank with chilled water while continuing to cause movement of the product within said container; and
f) after the product has reached a pre-selected temperature removing the container from the process tank and storing the container in refrigerated storage for shipment or sale.

2. The process of claim 1 wherein the step of causing the contents of the container to move is by vibrating the container.

3. The process of claim 1 wherein the product is liquid and the contents are caused to move because of convection current set up in the liquid as heated water contacts the container wall and transfers heat to the liquid.

4. The process of claim 1 wherein the containers is rigid or is semi-rigid having flexible walls.

5. The process of claim 4 wherein the step of causing the container contents to move is by directing a spray of water against the container.

6. The process of claim 4 wherein the step of causing the contents of the container to move is by pulsing water flow against the container.

7. The process of claim 4 wherein varying water pressure against the flexible walls of the container causes the product within the container to move and flow.

8. The process of claim 1 wherein the product is a milk product, the treatment is a pasteurization process wherein the pre-selected heating temperature is about 160° F., the heating time is about 30 minutes, and the temperature of the chilled water is about 40° F.

9. The process of claim 1 including the step of heating water and storing it in a hot water storage tank, at a predetermined temperature, subsequently filling the process tank with said heated water, and removing the water from the process tank by returning at least a portion of it to the storage tank.

10. The process of claim 1 including the step of filling the process tank by heating water in line as it fills the tank.

11. The process of claim 1 wherein the containers are selected from the group consisting of plastic bottles and plastic pouches.

12. The process of claim 8 wherein the milk product is raw milk.

13. The process of claim 8 wherein the milk product is yogurt made from raw milk.

14. A process for treating a farm product in a rigid or semi-rigid container by heating and cooling while the container is positioned in a process tank to reduce contamination and enhance the flavor of the product comprising the steps of:
a) providing heated water in a hot water storage tank at a pre-selected temperature, said water being maintained at the pre-selected temperature which is sufficiently high to pasteurize a food product;
b) filling the process tank with heated water from said hot water storage tank source;
c) circulating the heated water from said process tank to said storage tank to maintain a pre-selected minimum temperature, the water in said circulating and filling step being directed against the walls of said container in a manner to cause movement of the product within the containers;
d) stopping said circulation of heated water and storing a portion of said water in said storage tank;
e) filling the process tank with ambient water and allowing it to remain for a pre-determined period;
f) removing said ambient water from the process tank and filling the process tank with chilled water from a chiller;
g) circulating the chilled water within the process tank for a pre-determined period of time while causing the product within the container to move in order to bring the temperature of the product in the containers to below about 40° F.; and
h) removing said containers and maintaining them in a chilled state for transportation and sale.

15. The process of claim 14 wherein product is a liquid that has rigid or semi-rigid walls, movement within the container is caused by convection as heat is transferred through the walls from the heated water to the liquid product.

16. A process for treating a farm product in a rigid or semi-rigid container by heating and cooling while the container is positioned in a process tank to reduce contamination and enhance the flavor of the product comprising the steps of:
a) filling the process tank with heated water from an in-line source, said water being at a pre-selected temperature;
b) directing the heated water during the filling step;
c) maintaining the temperature of the water in the process tank at a pre-selected level and period of time then draining the tank;
d) filling the process tank with ambient water and allowing it to remain for a pre-determined period;
e) removing said ambient water from the process tank and filling the process tank with chilled water from a chiller;
f) circulating the chilled water within the process tank for a pre-determined period of time while causing the product within the container to move in order to bring the temperature of the product in the containers to below about 40° F.; and
g) removing said containers and maintaining them in a chilled state for transportation and sale.
